(19) United States
(12) Patent Application Publication
(10) Pub. No.: US 2026/0228542 A1
(43) Pub. Date: Aug. 6, 2026

(54) METHOD AND APPARATUS FOR TRAINING TEXT PREDICTION MODEL, AND TEXT PREDICTION METHOD AND APPARATUS

(71) Applicant: ALIBABA INNOVATION PRIVATE LIMITED, Singapore (SG)

(72) Inventors: Binyuan HUI, Beijing (CN); Jiaxi Yang, Beijing (CN); Binhua LI, Beijing (CN); Fei HUANG, Sunnyvale, CA (US); Yongbin LI, Beijing (CN)

(21) Appl. No.: 19/159,600

(22) PCT Filed: Apr. 9, 2024
(86) PCT No.: PCT/SG2024/050244

§ 371 Date: Aug. 25, 2025

(30) Foreign Application Priority Data
Apr. 23, 2023 (CN) 202310459343.3

(51) Int. Cl. G06N 3/09; G06N 3/045

(52) U.S. Cl. CPC G06N 3/09; G06N 3/045

(57) ABSTRACT

Disclosed in the embodiments of the present disclosure are a method and apparatus for training a text prediction model, and a text prediction method and apparatus. A training sample set is used for training a large language model (LLM) to obtain a text prediction model. In this mode, labeled samples are substantively used for training the large language model, and in an updating process of a second key matrix and a second value matrix, a second key matrix and a second value matrix obtained through a previous round of iteration and a first key matrix and a first value matrix generated by a current input feature matrix are used, so that both historical information and information of a current input text are kept, and the large language model can fully understand and learn the labeled samples.

### CROSS-REFERENCE TO RELATED APPLICATIONS

The present disclosure claims priority of Chinese Patent Application No. 202310459343.3, filed to China National Intellectual Property Administration on Apr. 23, 2023 and titled “METHOD AND APPARATUS FOR TRAINING TEXT PREDICTION MODEL, AND TEXT PREDICTION METHOD AND APPARATUS”, the content of which is hereby incorporated by reference in its entirety.

### TECHNICAL FIELD

The present disclosure relates to the field of natural language processing technologies, and in particular, to a method and apparatus for training a text prediction model, and a text prediction method and apparatus.

### BACKGROUND OF THE INVENTION

An objective of Natural Language Processing (NLP) research is to enable a machine to understand human language. A Large Language Model (LLM) is a core tool in the field of natural language processing, and refers to a deep learning model having large-scale parameters (usually hundreds of millions or more).

Because of having an extremely high learning capability, the LLM is widely applied to the field of text prediction. In-context learning is currently one of text prediction manners used by the LLM. The so-called in-context learning means that after labeled data is given, the LLM performs observation and induction, and predicts unlabeled data. The in-context learning usually does not have a training process, and consequently has a poor prediction effect when applied to text prediction. Therefore, there is an urgent need for a manner capable of improving an LLM-based text prediction effect in an in-context learning scenario.

### SUMMARY OF THE INVENTION

In view of this, embodiments of the present disclosure provide a method and apparatus for training a text prediction model, and a text prediction method and apparatus, so as to improve an LLM-based text prediction effect in an in-context learning scenario.

The present disclosure provides the following solutions.

According to a first aspect, a method for training a text prediction model is provided. The method includes the following steps.

A training data set is obtained, the training data set including input text samples and output labels corresponding to the input text samples.

The text prediction model is trained by using a text sequence including an input text sample and an output label corresponding to the input text sample as an input of the text prediction model, where the text prediction model is a large language model, and the large language model includes multiple layers of concatenated Transformer networks.

In the training, each Transformer network is used as a current Transformer network layer to execute: determining, in a current round of iteration, a first key matrix, a first value matrix, and a first query matrix by using a feature representation outputted by a previous network layer; splicing the first key matrix and a second key matrix that is obtained by the current Transformer network layer in a previous round of iteration, to obtain a third key matrix, and splicing the first value matrix and a second value matrix that is obtained by the current Transformer network layer in the previous round of iteration, to obtain a third value matrix; performing processing of a self-attention mechanism by using the third key matrix, the third value matrix, and the first query matrix, to obtain a feature representation outputted by the current Transformer network layer; updating the second key matrix by using the first key matrix, and determining an updated second key matrix as a second key matrix that is obtained by the current Transformer network layer in the current round of iteration; and updating the second value matrix by using the first value matrix, and determining an updated second value matrix as a second value matrix that is obtained by the current Transformer network layer in the current round of iteration.

According to some embodiments of the present disclosure, the large language model further includes an embedding network, and the text prediction model further includes a prediction network.

The embedding network is used for performing embedding processing on the text sequence.

In response to the current Transformer network layer being a first Transformer network layer, the feature representation outputted by the previous network layer is a feature representation outputted by the embedding network. In response to the current Transformer network layer not being the first Transformer network layer, the feature representation outputted by the previous network layer is a feature representation outputted by a previous Transformer network layer.

The prediction network is used for predicting, by using a feature representation outputted by a last Transformer network layer, an output label corresponding to an input text sample.

According to some embodiments of the present disclosure, an operation of updating the second key matrix by using the first key matrix includes the following steps. The second key matrix that is obtained by the current Transformer network layer in the previous round of iteration is updated in a manner of momentum gradient descent by using the first key matrix.

An operation of updating the second value matrix by using the first value matrix includes the following steps. The second value matrix that is obtained by the current Transformer network layer in the previous round of iteration is updated in a manner of momentum gradient descent by using the first value matrix.

According to some embodiments of the present disclosure, an operation of updating, in the manner of momentum gradient descent by using the first key matrix, the second key matrix that is obtained by the current Transformer network layer in the previous round of iteration includes the following steps. Element-by-element subtraction is performed by using the first key matrix and the second key matrix that is obtained by the current Transformer network layer in the previous round of iteration, to obtain a key matrix gradient. Weighted summation is performed by using a key matrix momentum that is obtained by the current Transformer network layer in the previous round of iteration and the key matrix gradient, to obtain a key matrix momentum that is obtained by the current Transformer network layer in the current round of iteration. The updated second key matrix is obtained by using the key matrix momentum that is obtained by the current Transformer network layer in the current round of iteration and the second key matrix that is obtained by the current Transformer network layer in the previous round of iteration.

An operation of updating, in the manner of momentum gradient descent by using the first value matrix, the second value matrix that is obtained by the current Transformer network layer in the previous round of iteration includes the following steps. Element-by-element subtraction is performed by using the first value matrix and the second value matrix that is obtained by the current Transformer network layer in the previous round of iteration, to obtain a value matrix gradient. Weighted summation is performed by using a value matrix momentum that is obtained by the current Transformer network layer in the previous round of iteration and the value matrix gradient, to obtain a value matrix momentum that is obtained by the current Transformer network layer in the current round of iteration. The updated second value matrix is obtained by using the value matrix momentum that is obtained by the current Transformer network layer in the current round of iteration and the second value matrix that is obtained by the current Transformer network layer in the previous round of iteration.

According to some embodiments of the present disclosure, after each round of iteration is completed, in response to determining that a preset training termination condition is satisfied, a second key matrix and a second value matrix of each Transformer network layer that are obtained in the current iteration are stored as a second key matrix and a second value matrix of each Transformer network layer that are obtained through training respectively.

According to a second aspect, a text prediction method is provided. The method includes the following steps.

An input text is obtained.

A text sequence including the input text is inputted into a text prediction model, to obtain an output label corresponding to the input text. The text prediction model is a large language model, and the large language model includes multiple layers of concatenated Transformer networks.

Each Transformer network is used as a current Transformer network layer to execute: determining a first key matrix, a first value matrix, and a first query matrix by using a feature representation outputted by a previous network layer; splicing the first key matrix and a second key matrix that is obtained through pre-training by the current Transformer network layer, to obtain a third key matrix, and splicing the first value matrix and a second value matrix that is obtained through pre-training by the current Transformer network layer, to obtain a third value matrix; and performing processing of a self-attention mechanism by using the third key matrix, the third value matrix, and the first query matrix, to obtain a feature representation outputted by the current Transformer network layer.

According to some embodiments of the present disclosure, the large language model further includes an embedding network, and the text prediction model further includes a prediction network.

The embedding network is used for performing embedding processing on the text sequence.

In response to the current Transformer network layer is a first Transformer network layer, the feature representation outputted by the previous network layer is a feature representation outputted by the embedding network. In response to the current Transformer network layer being the first Transformer network layer, the feature representation outputted by the previous network layer is a feature representation outputted by a previous Transformer network layer.

The prediction network is used for predicting, by using a feature representation outputted by a last Transformer network layer, the output label corresponding to the input text.

According to a third aspect, a method for training a text prediction model is provided. The method includes the following steps.

A training data set is obtained, the training data set including input text samples and sentiment category labels corresponding to the input text samples.

The text prediction model is trained by using a text sequence including an input text sample and a sentiment category label corresponding to the input text sample as an input of the text prediction model, where the text prediction model is a large language model, and the large language model includes multiple layers of concatenated Transformer networks.

In the training, each Transformer network is used as a current Transformer network layer to execute: determining, in a current round of iteration, a first key matrix, a first value matrix, and a first query matrix by using a feature representation outputted by a previous network layer; splicing the first key matrix and a second key matrix that is obtained by the current Transformer network layer in a previous round of iteration, to obtain a third key matrix, and splicing the first value matrix and a second value matrix that is obtained by the current Transformer network layer in the previous round of iteration, to obtain a third value matrix; performing processing of a self-attention mechanism by using the third key matrix, the third value matrix, and the first query matrix, to obtain a feature representation outputted by the current Transformer network layer; updating the second key matrix by using the first key matrix, and determining an updated second key matrix as a second key matrix that is obtained by the current Transformer network layer in the current round of iteration; and updating the second value matrix by using the first value matrix, and determining an updated second value matrix as a second value matrix that is obtained by the current Transformer network layer in the current round of iteration.

According to a fourth aspect, a sentiment analysis method is provided. The method includes the following steps.

An input text is obtained.

A text sequence including the input text is inputted into a text prediction model, to obtain a sentiment category label corresponding to the input text, where the text prediction model is a large language model, and the large language model includes multiple layers of concatenated Transformer networks.

Each Transformer network is used as a current Transformer network layer to execute: determining a first key matrix, a first value matrix, and a first query matrix by using a feature representation outputted by a previous network layer; splicing the first key matrix and a second key matrix that is obtained through pre-training by the current Transformer network layer, to obtain a third key matrix, and splicing the first value matrix and a second value matrix that is obtained through pre-training by the current Transformer network layer, to obtain a third value matrix; and performing processing of a self-attention mechanism by using the third key matrix, the third value matrix, and the first query matrix, to obtain a feature representation outputted by the current Transformer network layer.

According to a fifth aspect, a text prediction method is provided. The method is performed by a cloud server and includes the following steps.

An input text is obtained from a user terminal.

A text sequence including the input text is inputted into a text prediction model, to obtain an output label corresponding to the input text.

Service content corresponding to the output label is determined, and the service content is sent to the user terminal.

The text prediction model is a large language model, and the large language model includes multiple layers of concatenated Transformer networks.

Each Transformer network is used as a current Transformer network layer to execute: determining a first key matrix, a first value matrix, and a first query matrix by using a feature representation outputted by a previous network layer; splicing the first key matrix and a second key matrix that is obtained through pre-training by the current Transformer network layer, to obtain a third key matrix, and splicing the first value matrix and a second value matrix that is obtained through pre-training by the current Transformer network layer, to obtain a third value matrix; and performing processing of a self-attention mechanism by using the third key matrix, the third value matrix, and the first query matrix, to obtain a feature representation outputted by the current Transformer network layer.

According to a sixth aspect, a text prediction model training apparatus is provided. The apparatus includes:
a sample obtaining unit, configured to obtain a training data set, the training data set including input text samples and output label samples corresponding to the input text samples; and
a model training unit, configured to train the text prediction model by using a text sequence including an input text sample and an output label corresponding to the input text sample as an input of the text prediction model, where the text prediction model is a large language model, and the large language model includes multiple layers of concatenated Transformer networks; and in the training, each Transformer network is used as a current Transformer network layer to execute: determining, in a current round of iteration, a first key matrix, a first value matrix, and a first query matrix by using a feature representation outputted by a previous network layer; splicing the first key matrix and a second key matrix that is obtained by the current Transformer network layer in a previous round of iteration, to obtain a third key matrix, and splicing the first value matrix and a second value matrix that is obtained by the current Transformer network layer in the previous round of iteration, to obtain a third value matrix; performing processing of a self-attention mechanism by using the third key matrix, the third value matrix, and the first query matrix, to obtain a feature representation outputted by the current Transformer network layer; updating the second key matrix by using the first key matrix, and determining an updated second key matrix as a second key matrix that is obtained by the current Transformer network layer in the current round of iteration; and updating the second value matrix by using the first value matrix, and determining an updated second value matrix as a second value matrix that is obtained by the current Transformer network layer in the current round of iteration.

According to a seventh aspect, a text prediction apparatus is provided. The apparatus includes:
a text obtaining unit, configured to obtain an input text; and
a text prediction unit, configured to input a text sequence including the input text into a text prediction model, to obtain an output label corresponding to the input text, where the text prediction model is a large language model, and the large language model includes multiple layers of concatenated Transformer networks; and each Transformer network is used as a current Transformer network layer to execute: determining a first key matrix, a first value matrix, and a first query matrix by using a feature representation outputted by a previous network layer; splicing the first key matrix and a second key matrix that is obtained through pre-training by the current Transformer network layer, to obtain a third key matrix, and splicing the first value matrix and a second value matrix that is obtained through pre-training by the current Transformer network layer, to obtain a third value matrix; and performing processing of a self-attention mechanism by using the third key matrix, the third value matrix, and the first query matrix, to obtain a feature representation outputted by the current Transformer network layer.

According to an eighth aspect, a computer-readable storage medium storing a computer program is provided. The computer program, when executed by a processor, implements the steps of any method according to the first aspect.

According to a ninth aspect, an electronic device is provided. The electronic device includes:
at least one processor; and
a memory associated with the at least one processor, where the memory is configured to store program instructions, and the program instructions, when read and executed by the at least one processor, performs the steps of any method according to the first aspect.

According to specific embodiments provided in the present disclosure, the present disclosure discloses the following technical effects.
1) According to the present disclosure, the training sample set is used for training the LLM to obtain the text prediction model. In this mode, labeled samples are substantively used for training the LLM, and in an updating process of the second key matrix and the second value matrix, the second key matrix and the second value matrix obtained through the previous round of iteration and the first key matrix and the first value matrix generated by the current input feature matrix are used, so that both historical information and information of a current input text are kept, and the LLM can fully understand and learn the labeled samples, thereby improving an LLM-based text prediction effect.
2) In the present disclosure, in an LLM training process, the second key matrix and the second value matrix that are used during each round of iteration are obtained from the previous round of iteration, and are updated and then used in a next round of iteration. The mode of forward optimizing a model needs to optimize the second key matrix and the second value matrix of each Transformer network, greatly reduces model parameters needing to be updated, reduces costs of model training, and improves the efficiency.
3) In the embodiments of the present disclosure, the second key matrix and the second value matrix of each Transformer network are updated in the manner of momentum gradient descent, so that a gradient descent speed can be increased, iteration efficiency is higher, and trapping into a local minimum value is avoided.
4) In the present disclosure, the second key matrix and the second value matrix of each Transformer network that are obtained after the text prediction model is trained are used in the prediction process. Compared with ordinary in-context learning, the second key matrix and the second value matrix of each Transformer network include better observation and understanding of labeled sample data by the text prediction model, which can significantly improve prediction accuracy.

Certainly, any product implementing the present disclosure does not necessarily achieve all the advantages described above.

### BRIEF DESCRIPTION OF DRAWINGS

To describe the technical solutions in the embodiments of the present disclosure or the related art more clearly, the following briefly introduces the accompanying drawings required in the embodiments. It is apparent that the accompanying drawings in the following description show some embodiments of the present disclosure. A person having ordinary skill in the art may still derive other drawings from these accompanying drawings without creative efforts.

FIG. 1 is a schematic principle diagram of conventional LLM-based in-context learning.

FIG. 2 is a diagram of a system architecture applied to some embodiments of the present disclosure.

FIG. 3 is a flowchart of a method for training a text prediction model according to some embodiments of the present disclosure.

FIG. 4 is a schematic structural diagram of a text prediction model according to some embodiments of the present disclosure.

FIG. 5 is a schematic principle diagram of a Transformer network according to some embodiments of the present disclosure.

FIG. 6 is a flowchart of a text prediction method according to some embodiments of the present disclosure.

FIG. 7 is a schematic principle diagram of LLM-based in-context learning according to some embodiments of the present disclosure.

FIG. 8 is a schematic block diagram of a model training apparatus according to some embodiments of the present disclosure.

FIG. 9 is a schematic block diagram of a text prediction apparatus according to some embodiments of the present disclosure.

FIG. 10 is a schematic block diagram of an electronic device according to some embodiments of the present disclosure.

FIG. 11 is a schematic structural diagram of a processor for implementing the embodiments of the present disclosure.

### DETAILED DESCRIPTION OF THE INVENTION

The following clearly and completely describes the technical solutions in embodiments of the present disclosure with reference to the accompanying drawings in the embodiments of the present disclosure. Apparently, the described embodiments are some rather than all of the embodiments of the present disclosure. All other embodiments obtained by a person having ordinary skill in the art based on the embodiments of the present disclosure shall fall within the protection scope of the present disclosure.

The terms used in the embodiments of the present disclosure are for the purpose of illustrating specific embodiments, and are not intended to limit the present disclosure. The terms “a”, “the”, and “this” of singular forms used in the embodiments of the present disclosure and the appended claims are also intended to include plural forms, unless otherwise specified in the context clearly.

It should be understood that terms “and/or” used herein is an association relationship for describing associated objects and represents that three relationships may exist. For example, A and/or B may represent the following three cases: A exists alone, A and B exist at the same time, and B exists alone. In addition, in this specification, the character “/” usually indicates an “or” relationship between the associated objects.

Depending on the context, the word “if” used here can be interpreted as “at the time”, “when”, or “in response to determining”, or “in response to detecting”. Similarly, depending on the context, the phrases “in response to . . . being determined” or “in response to (a condition or event stated) . . . being detected” can be interpreted as “when . . . is determined”, “in response to determining”, “when (a condition or event stated) . . . is detected”, or “in response to determining a condition or event stated”.

A conventional LLM-based in-context learning process is shown in FIG. 1. Labeled sample data and an input text to be predicted are input to an LLM together, and the LLM observes and induces the labeled sample data, to predict an output label corresponding to the input text. The in-context learning process does not have a training process, and consequently has a poor text prediction effect.

In response to a text prediction model being trained in advance based on the LLM in a conventional back propagation training manner. That is, the LLM is trained by using the labeled sample data, a gradient is generated by using a loss function to update a model parameter. Since a model parameter quantity of the LLM is huge, the conventional back propagation training manner causes problems of extremely high costs and low efficiency.

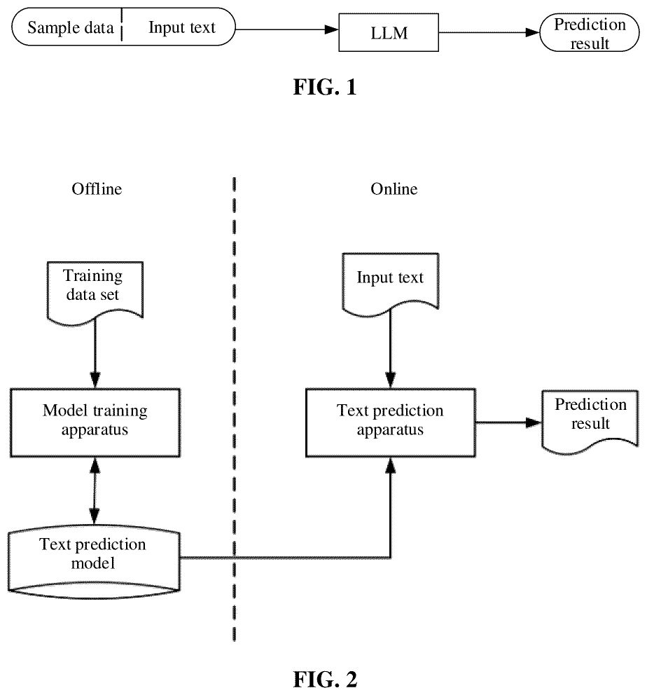

In view of this, the present disclosure provides a brand new idea, to train a text prediction model in advance based on an LLM in a forward training manner. To facilitate understanding of the present disclosure, a system architecture on which the present disclosure is based is first briefly described. FIG. 2 shows an exemplary system architecture applied to some embodiments of the present disclosure. As shown in FIG. 2, the system architecture includes a model training apparatus for training a text prediction model offline, and a text prediction apparatus for predicting an input text online.

After obtaining a training data set, the model training apparatus performs model training by using the method provided in the embodiments of the present disclosure, to obtain the text prediction model.

The text prediction apparatus predicts the input text by using the text prediction model obtained through training, and an obtained prediction result is an output label corresponding to the input text. For example, the input text is predicted to obtain categories such as sentiments and intents.

The model training apparatus and the text prediction apparatus are separately set as independent servers, or are set in a same server or server group, or are set in independent cloud servers or a same cloud server. A cloud server, also referred to as a cloud computing server or a cloud host, is a host product in a cloud computing service system, to resolve defects of high management difficulty and poor service scalability that exist in conventional physical host and virtual private server (VPS) services. The model training apparatus and the text prediction apparatus are alternatively set in a computer terminal having a relatively strong computing capability.

In addition, besides performing text prediction online, the text prediction apparatus further perform text prediction offline. For example, text prediction is performed in batches on texts in a database as input texts separately, and a prediction result is stored in the database for subsequent querying or invoking.

It should be understood that the number of model training apparatuses, the number of text prediction apparatuses, and the number of text prediction models in FIG. 2 are exemplary. According to implementation needs, there are any number of model training apparatuses, any number of text prediction apparatuses, and any number of text prediction models.

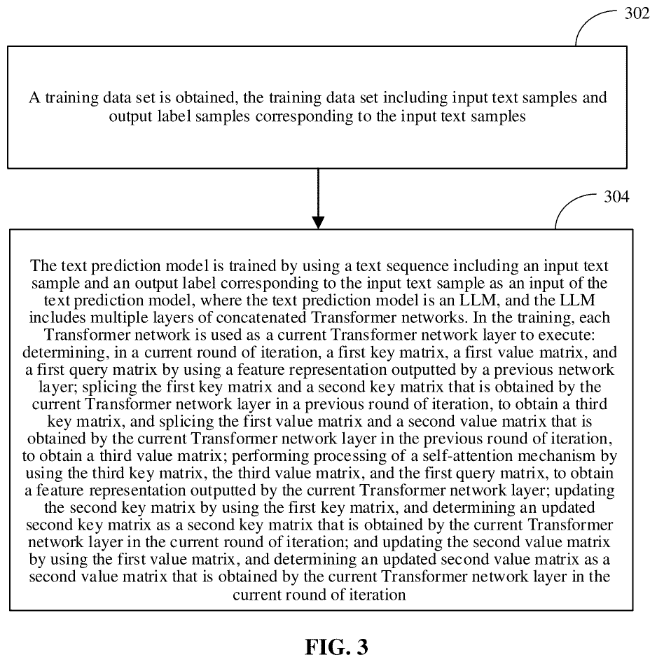

FIG. 3 is a flowchart of a method for training a text prediction model according to some embodiments of the present disclosure. The method is performed by the model training apparatus in the system shown in FIG. 2. As shown in FIG. 3, the method may include the following steps.

In step 302, a training data set is obtained, the training data set including input text samples and output label samples corresponding to the input text samples.

In step 304, the text prediction model is trained by using a text sequence including an input text sample and an output label corresponding to the input text sample as an input of the text prediction model, where the text prediction model is an LLM, and the LLM includes multiple layers of concatenated Transformer networks. In the training, each Transformer network is used as a current Transformer network layer to execute: determining, in a current round of iteration, a first key matrix, a first value matrix, and a first query matrix by using a feature representation outputted by a previous network layer; splicing the first key matrix and a second key matrix that is obtained by the current Transformer network layer in a previous round of iteration, to obtain a third key matrix, and splicing the first value matrix and a second value matrix that is obtained by the current Transformer network layer in the previous round of iteration, to obtain a third value matrix; performing processing of a self-attention mechanism by using the third key matrix, the third value matrix, and the first query matrix, to obtain a feature representation outputted by the current Transformer network layer; updating the second key matrix by using the first key matrix, and determining an updated second key matrix as a second key matrix that is obtained by the current Transformer network layer in the current round of iteration; and updating the second value matrix by using the first value matrix, and determining an updated second value matrix as a second value matrix that is obtained by the current Transformer network layer in the current round of iteration.

It can be seen from the foregoing process that according to the present disclosure, the training sample set is used for training the LLM to obtain the text prediction model. In this mode, labeled samples are substantively used for training the LLM, and in an updating process of the second key matrix and the second value matrix, the second key matrix and the second value matrix obtained through the previous round of iteration and the first key matrix and the first value matrix generated by a current input feature matrix are used, so that both historical information and information of a current input text are kept, and the LLM can fully understand and learn the labeled samples, thereby improving an LLM-based text prediction effect.

In addition, in an LLM training process, the second key matrix and the second value matrix that are used during each round of iteration are obtained from the previous round of iteration, and are updated and then used in a next round of iteration. The mode of forward optimizing a model needs to optimize the second key matrix and the second value matrix of each Transformer network, greatly reduces model parameters needing to be updated, reduces costs of model training, and improves the efficiency.

It should be noted that, limitations such as “first” and “second” involved in the present disclosure do not have limitations in aspects such as size, sequence, and quantity, and are used for distinguishing in names. For example, the “first key matrix”, a “second key matrix”, and a “third key matrix” are used for distinguishing three key matrices in names. For another example, a “first value matrix”, a “second value matrix”, and a “third value matrix” are used for distinguishing three value matrices in names.

The following separately describes the steps in the foregoing process in detail. First, in step 302, an operation of “obtaining the training data set” is described in detail with reference to some embodiments.

The training data set obtained in this step includes multiple training samples. Each training sample includes the input text sample and the output label sample corresponding to the input text sample. Each training sample is represented as (xᵢ, yᵢ), xᵢ being an ith input text sample, and yᵢ being an output label sample corresponding to xᵢ, that is, the output label marked by xᵢ.

The input text sample is a sentence, a paragraph, an article, a phrase, or the like. The output label corresponds to different content in different application scenarios, that is, the output label is a category label, or a text label. For example, in a sentiment analysis scenario, the output label is a sentiment type label, that is, a sentiment type marked for the input text sample. For another example, in an intent recognition scenario, the output label is an intent type label, that is, an intent type marked for the input text sample. For another example, in an automatic question-answering scenario, the output label is an answer text label, that is, an answer text marked for a question when the input text sample is used as the question.

The output label sample is manually marked, or is automatically marked in an existing mining manner. This is not limited in the present disclosure.

In step 304, an operation of “training the text prediction model by using the text sequence including the input text sample and the output label corresponding to the input text sample as the input of the text prediction model” is described in detail below with reference to some embodiments.

The text prediction model in some embodiments of the present disclosure is implemented based on the LLM. The LLM is a pre-trained large language model. In some embodiments of the present disclosure, model optimization is further performed based on the LLM, so that the LLM can quickly understand a sample set and a training data set that are marked. To fully use an existing language understanding capability of the LLM, in a training process, the text sequence is constructed by using each input text sample and an output label corresponding to this input text sample. For example, the input text sample xᵢ and the corresponding output label yᵢ are spliced to obtain the text sequence Tᵢ, to be inputted into the text prediction model, that is, the LLM. When xᵢ and yᵢ are spliced, indication information for xᵢ and yᵢ is added. For example, the input text sample “food is yummy” and the output label “positive” constitute the text sequence “Evaluation: food is yummy. Sentiment: positive”. “Evaluation” and “Sentiment” are indication information for the input text sample and the output label.

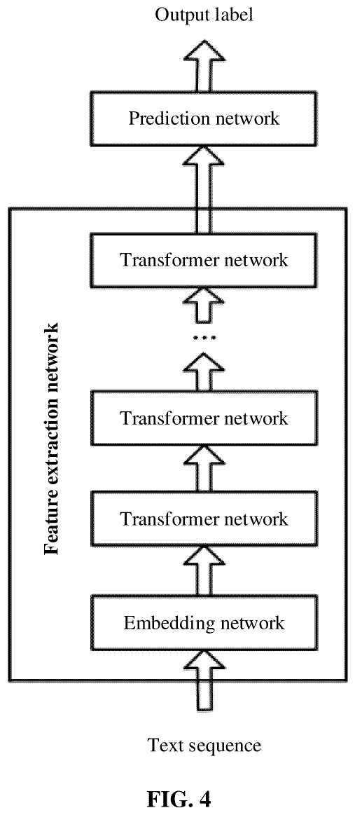

An overall framework of the text prediction model used in some embodiments of the present disclosure is shown in FIG. 4, and mainly includes a feature extraction network and a prediction network.

The feature extraction network is configured to extract a feature representation from an input text sequence. The prediction network is used for predicting an output label of the input text sample by using the feature representation extracted by the feature extraction network. In addition to the framework, other frameworks such as an encoder-decoder framework are also used, and are not enumerated herein. However, the frameworks are all implemented based on the LLM. For example, the feature extraction network is implemented based on the LLM, and the encoder is implemented based on the LLM. In some embodiments of the present disclosure, the framework shown in FIG. 4 is used as an example.

Given that the text prediction model of the present disclosure is implemented based on the LLM, the feature extraction network may specifically include an embedding network and multiple layers of concatenated Transformer networks.

The embedding network is used for performing Embedding processing on the input text sequence. More specifically, the Embedding processing is performed on each Token of the input text sequence. Each Token of the text sequence refers to a token constituting the text sequence. For the text sequence, the text sequence is segmented into character or word sequences, and the character or word, a start character, and a delimiter in the text sequence are all Tokens.

The foregoing Token-based Embedding processing includes at least: word Embedding and position Embedding. The word Embedding is to perform word vector encoding on each Token, to obtain a word vector representation. The position Embedding is to encode a position of each Token in the to-be-predicted text sequence, to obtain a position representation.

The Transformer network is a model that encodes each input Token by using a self-attention mechanism to convert the input Token into a feature representation. In the forward learning manner provided in some embodiments of the present disclosure, a self-attention part in the Transformer is required to be modified.

FIG. 5 is a schematic principle diagram of a Transformer network according to some embodiments of the present disclosure. As shown in FIG. 5, each Transformer network includes “transverse” processing on a feature representation and “longitudinal” update processing on a model parameter. It should be noted that “transverse” and “longitudinal” herein are directions shown in the figure, are names used for ease of description, and do not have actual directional meanings.

In a “transverse” processing process shown in FIG. 5, first, a current Transformer network determines a first key matrix K_{X}, a first value matrix V_{X}, and a first query matrix Q by using a feature representation

$${X}_{t}^{l - 1}$$

outputted by a previous network layer. In response to the current Transformer network being a first Transformer network layer, the foregoing

$${X}_{t}^{l - 1}$$

is a feature representation outputted by the embedding network. In response to the current Transformer network being not the first Transformer network layer, the foregoing

$${X}_{t}^{l - t}$$

is a feature representation outputted by a previous Transformer network layer. In the figure, an example in which the current Transformer network layer is an lth Transformer network layer is used.

The subscript t in the figure represents a tth round of iteration in the training process of the text prediction model. In each round of iteration, a batch of training samples are collected from the training data set and inputted into the text prediction model for training. This part is similar to that of conventional model training, and is not described in detail.

The first key matrix K_{X}, the first value matrix V_{X}, and the first query matrix Q_{X} are determined by using the following formulas:

$${K}_{X} = {W}_{k} {X}_{t}^{l - 1} \qquad ( 1 )$$

$${V}_{X} = {W}_{v} {X}_{t}^{l - 1} \qquad ( 2 )$$

$$Q = {W}_{Q} {X}_{t}^{l - 1} \qquad ( 3 )$$

where W_{Q}, Wₖ, and Wᵥ are weight matrices, and are parameters learned by the LLM in a pre-training process.

Then, the first key matrix K_{X} and a second key matrix

$${K}_{t - 1}^{l}$$

that is obtained in a previous round of iteration by the current Transformer network layer are spliced, to obtain a third key matrix K, and the first value matrix V_{X} and a second value matrix

$${V}_{t - 1}^{l}$$

that is obtained in the previous round of iteration by the current Transformer network layer are spliced, to obtain a third value matrix V.

K and V are represented as:

$$K = \{ {K}_{t - 1}^{l} ‖ {K}_{X} \} \qquad ( 4 )$$

$$V = \{ {V}_{t - 1}^{l} ‖ {V}_{X} \} \qquad ( 5 )$$

where ∥ represents splicing processing.

The second key matrix and the second value matrix of each Transformer network are model parameters that need to be learned in a forward training process, and are continuously updated in each round of iteration. Each Transformer network corresponds to the second key matrix and the second value matrix.

Then, processing of a self-attention mechanism is performed by using the third key matrix K, the third value matrix V, and the first query matrix Q, to obtain a feature representation

$${X}_{t}^{i}$$

outputted by the current Transformer network layer. The processing of the self-attention mechanism is processing of an attention module and an FFN module, is not described in detail herein, and is represented as:

$${X}_{t}^{l} = Transformer ( K , V , Q ) \qquad ( 6 )$$

where Transformer ( ) is a processing function of the attention module and the FFN module. In the foregoing “transverse” processing process, the first key matrix KX and a second key matrix

$${K}_{t - 1}^{l}$$

that is obtained by the current Transformer network layer in a previous round of iteration are spliced, and the first value matrix V_{X} and the second value matrix

$${V}_{t - 1}^{l}$$

that is obtained by the current Transformer network layer in the previous round of iteration are spliced, which are considered as mixing information of “past and present” to obtain the third key matrix K and the third value matrix V, thereby satisfying the essence of in-context learning.

For the “longitudinal” processing process, first, the second key matrix

$${K}_{t - 1}^{i}$$

is updated by using the first key matrix K_{X}, and an updated second key matrix

$${K}_{t}^{l}$$

is used as a second key matrix that is obtained by the current Transformer network layer in the current round iteration, so as to be used in a next round of iteration. The second value matrix

$${V}_{t - 1}^{l}$$

is updated by using the first value matrix V_{X}, and an updated second value matrix

$${V}_{t}^{l}$$

is used as a second value matrix that is obtained by the current Transformer network layer in the current round of iteration, so as to be used in a next round of iteration. It can be seen that an update process of the parameters is a forward update process.

As some implementable manners, the second key matrix and the second value matrix are updated in a manner of momentum gradient descent. The so-called momentum gradient descent method means that in gradient descent, a parameter update direction in each iteration is opposite to a direction of momentum used in the current iteration. It may also be considered that a parameter update direction in each iteration is a weighted combination of an opposite direction of a current gradient and a previous parameter update direction. That is, a parameter update direction not only depends on a direction of a current gradient, but also depends on a past parameter update direction.

Using an example in which the second key matrix is updated, element-by-element subtraction is first performed by using the first key matrix K_{X} and the second key matrix

$${K}_{t - 1}^{l}$$

that is obtained by the current Transformer network layer in the previous round of iteration, to obtain a key matrix gradient

$${G}_{{K}_{t}^{i}} .$$

Then, weighted summation is performed by using a key matrix momentum

$${M}_{{K}_{t - 1}^{l}}$$

that is obtained by the current Transformer network layer in the previous round of iteration and the key matrix gradient

$${G}_{{K}_{t}^{i}} ,$$

to obtain a key matrix momentum

$${M}_{{K}_{t}^{i}}$$

that is obtained by the current Transformer network layer in the current round of iteration.

Then, the updated second key matrix

$${K}_{t}^{l}$$

is obtained by using the key matrix momentum

$${M}_{{K}_{t}^{l}}$$

that is obtained by the current Transformer network layer in the current round of iteration and the second key matrix

$${K}_{t}^{l}$$

that is obtained by the current Transformer network layer in the previous round of iteration.

The entire process is represented by the following formulas:

$${G}_{{K}_{t}^{l}} = {K}_{X} - {K}_{t - 1}^{l} \qquad ( 7 )$$

$${M}_{{K}_{t}^{l}} = ( 1 - β ) {M}_{{K}_{t - 1}^{l}} + β {G}_{{K}_{t}^{l}} \qquad ( 8 )$$

$${K}_{t}^{l} = {K}_{t - 1}^{l} + η {M}_{{K}_{t}^{l}} \qquad ( 9 )$$

where β and η are respectively a momentum weight and an update step size, both are preset hyper-parameters, and are empirical values or experimental values. For example, β is 0.9, and η is 0.01.

An update process of the second value matrix is as follows. Element-by-element subtraction is first performed by using the first value matrix V_{X} and the second value matrix

$${V}_{t - 1}^{l}$$

that is obtained by the current Transformer network layer in the previous round of iteration, to obtain a value matrix gradient

$${G}_{{V}_{t}^{l}} .$$

Then, weighted summation is performed by using a value matrix momentum

$${M}_{{V}_{t - 1}^{l}}$$

that is obtained by the current Transformer network layer in the previous round of iteration and the value matrix gradient

$${G}_{{V}_{t}^{i}} ,$$

to obtain a value matrix momentum

$${M}_{{V}_{t}^{i}}$$

that is obtained by the current Transformer network layer in the current round of iteration. Then, the updated second value matrix

$${V}_{t}^{l}$$

is obtained by using the value matrix momentum

$${M}_{{V}_{t - 1}^{i}}$$

that is obtained by the current Transformer network layer in the current round of iteration and the second value matrix

$${V}_{i - 1}^{l}$$

that is obtained by the current Transformer network layer in the previous round of iteration. The entire process is represented by the following formulas:

$${G}_{{V}_{t}^{l}} = {V}_{X} - {V}_{t - 1}^{l} \qquad ( 10 )$$

$${M}_{{V}_{t}^{l}} = ( 1 - β ) {M}_{{V}_{t - 1}^{l}} + β {G}_{{V}_{t}^{l}} \qquad ( 11 )$$

$${V}_{t}^{l} = {V}_{t - 1}^{l} + η {M}_{{V}_{t}^{l}} \qquad ( 12 )$$

In some embodiments of the present disclosure, when model training is performed, inputs are input text samples and output labels, and the Transformer network learns relationships between the input text samples and the output labels through self-attention processing. In the foregoing process, the key matrices and the value matrices are key carriers for expressing these relationships. The key matrix gradient and the value matrix gradient are considered as differences between relationships between input text samples and output labels that are learned through two rounds of iteration, and the obtained relationships tend to be consistent through continuous forward update.

The foregoing update process actually is performing information “blending” on the second key matrix and the second value matrix that are obtained in a previous round of iteration and the first key matrix and the first value matrix that are generated by a current input feature matrix, to generate the second key matrix and the second value matrix that are updated, that is, historical information and information about a current input text are retained, thereby implementing smooth update of parameters, and improving a text prediction capability of the model.

It can be seen from the foregoing embodiment that, an entire model update process involves update of such two main parameters as the second key matrix and the second value matrix, and parameters of basic networks of the model, for example, parameters related to the embedding network, the self-attention module, the FFN module, and the prediction network, do not need to be updated, thereby greatly reducing a quantity of parameters needing to be updated, reducing computation costs, and improving efficiency.

After each round of iteration is completed, whether a preset training termination condition is satisfied is determined. In response to the preset training termination condition being satisfied, the iteration is stopped, and the training terminates. In response to the preset training termination condition not being satisfied, a next round of iteration is performed. After the training terminates, the second key matrix and the second value matrix of each Transformer network layer that are obtained in the current iteration are stored as a second key matrix

$${K}_{T}^{i}$$

and a second value matrix

$${V}_{T}^{l}$$

of each Transformer network layer that are obtained through training respectively.

$${K}_{T}^{l} and {V}_{T}^{l}$$

are set to be used in a text prediction process. The training termination condition includes but is not limited to at least one of the following.

An accuracy on a verification set reaches a preset accuracy threshold, and multiple iterations reaches a preset iteration quantity threshold.

In the embodiments of the present disclosure, the second key matrix and the second value matrix of each Transformer network are updated in a manner of momentum gradient descent, so that a gradient descent speed can be increased, iteration efficiency is higher, and trapping into a local minimum value is avoided. In addition, besides the foregoing momentum gradient descent manner, other gradient descent manners may also be used, and are not listed one by one herein.

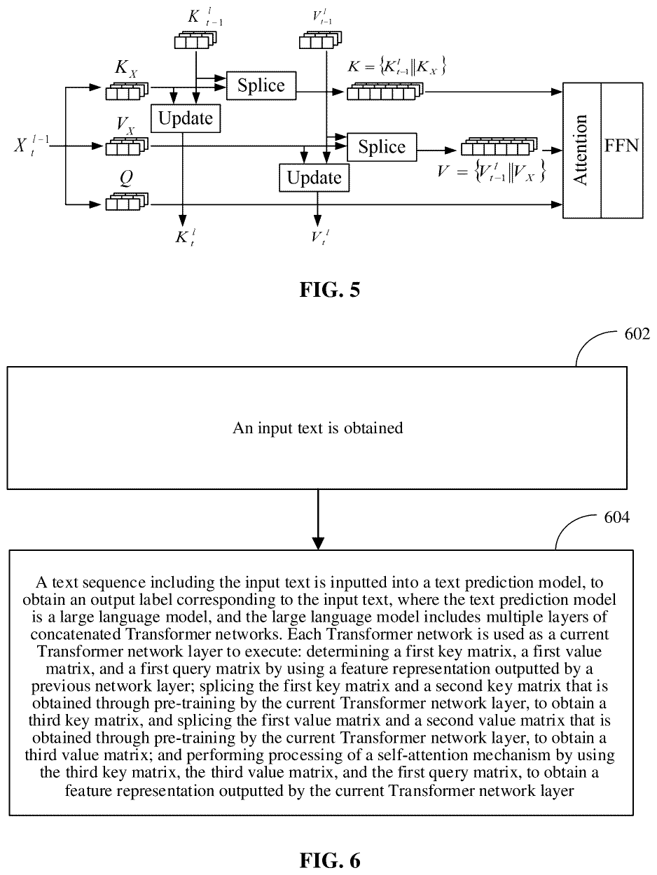

FIG. 6 is a flowchart of a text prediction method according to some embodiments of the present disclosure. The method is performed by the text prediction apparatus in the system architecture shown in FIG. 2. As shown in FIG. 6, the method includes the following steps.

In step 602: an input text is obtained.

The input text involved in this step is a text that is not marked with a corresponding output label, and is a sentence, a paragraph, an article, a phrase, or the like.

In step 604: a text sequence including the input text is inputted into a text prediction model, to obtain an output label corresponding to the input text, where the text prediction model is a large language model, and the large language model includes multiple layers of concatenated Transformer networks. Each Transformer network is used as a current Transformer network layer to execute: determining a first key matrix, a first value matrix, and a first query matrix by using a feature representation outputted by a previous network layer; splicing the first key matrix and a second key matrix that is obtained through pre-training by the current Transformer network layer, to obtain a third key matrix, and splicing the first value matrix and a second value matrix that is obtained through pre-training by the current Transformer network layer, to obtain a third value matrix; and performing processing of a self-attention mechanism by using the third key matrix, the third value matrix, and the first query matrix, to obtain a feature representation outputted by the current Transformer network layer.

The input text is used as the text sequence. Alternatively, the text sequence is formed by using the input text and indication information of the input text. Alternatively, the input text and a preset prompt text are spliced to form the text sequence. The prompt text is preset according to an actual scenario requirement, and is, for example, “The sentiment expressed by the sentence is [Mask]” during sentiment identification. [Mask] is a mask part, and by encoding and predicting the text sequence, the text prediction model actually predicts content of the [Mask] part.

For a structure of the text prediction model, refer to related records in the foregoing embodiments. In response to the framework shown in FIG. 4 being used, the text sequence is inputted into the embedding network. The embedding network is used for performing Embedding processing on the input text sequence. Then, the text sequence is encoded by using multiple concatenated Transformer networks, to obtain a feature representation of the text sequence. Finally, a prediction network predicts, by using the feature representation of the text sequence, the output label corresponding to the input text.

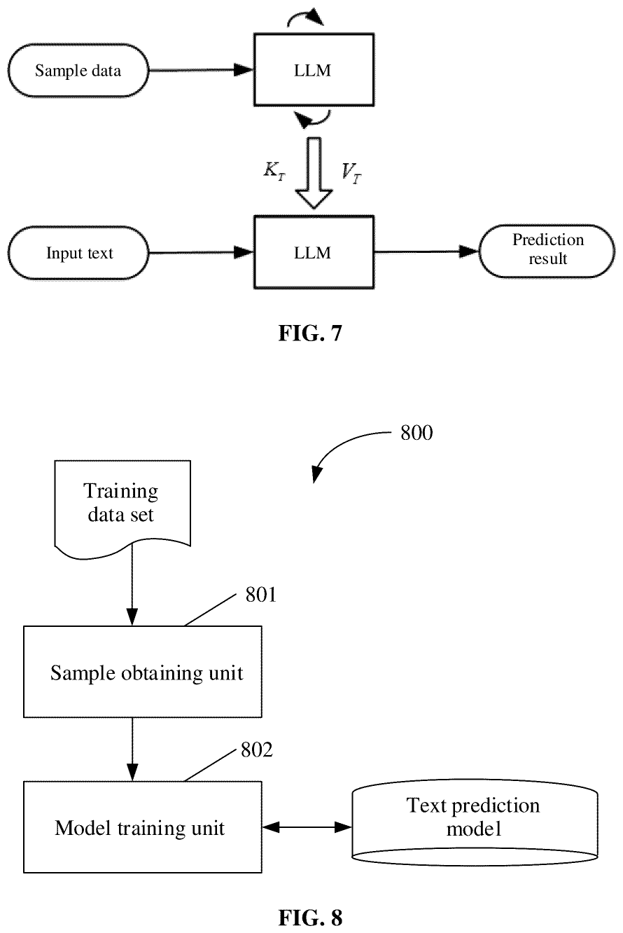

A processing process of each Transformer network is shown in FIG. 7. A first key matrix K_{X}, a first value matrix V_{X}, and a first query matrix Q are first determined by using

$${X}_{q}^{i - 1}$$

in response to a feature representation outputted by a previous network layer being

$${X}_{q}^{l - 1} .$$

In response to the current Transformer network being the first Transformer network layer, the foregoing

$${X}_{q}^{l - 1}$$

is a feature representation outputted by the embedding network. In response to the current Transformer network not being the first Transformer network layer, the foregoing

$${X}_{q}^{l - 1}$$

is a feature representation outputted by a previous Transformer network layer. In the figure, an example in which the current Transformer network layer is an lth Transformer network layer is used.

The first key matrix K_{X}, the first value matrix V_{X}, and the first query matrix Q_{X} are determined by using the following formulas:

$${K}_{X} = {W}_{k} {X}_{q}^{l - 1} \qquad ( 13 )$$

$${V}_{X} = {W}_{v} {X}_{q}^{l - 1} \qquad ( 14 )$$

$$Q = {W}_{Q} {X}_{q}^{l - 1} \qquad ( 15 )$$

Then, the first key matrix K_{X} and the second key matrix

$${K}_{T}^{l}$$

that is obtained through pre-training by the current Transformer network layer are spliced, to obtain the third key matrix K, and the first value matrix V_{X} and the second value matrix

$${V}_{T}^{l}$$

that is obtained through pre-training by the current Transformer network layer are spliced, to obtain the third value matrix V.

K and V are represented as:

$$K = \{ {K}_{T}^{l} ‖ {K}_{X} \} \qquad ( 16 )$$

$$V = \{ {V}_{T}^{l} ‖ {V}_{X} \} \qquad ( 17 )$$

Then, processing of a self-attention mechanism is performed by using the third key matrix K, the third value matrix V, and the first query matrix Q, to obtain a feature representation

$${X}_{q}^{l}$$

outputted by the current Transformer network layer. The processing of the self-attention mechanism is processing of an attention module and an FFN module, is not described in detail herein, and are represented as:

$${X}_{q}^{l} = Transformer ( K , V , Q ) \qquad ( 18 )$$

It can be seen from the foregoing prediction process that, in the prediction process,

$${K}_{T}^{l} and {V}_{T}^{l}$$

obtained after model training are used. Compared with ordinary in-context learning,

$${K}_{T}^{l} and {V}_{T}^{l}$$

include better observation and understanding of labeled sample data by the text prediction model, which can significantly improve prediction accuracy.

It can be seen from the foregoing training and prediction processes that, the principle of in-context learning used in some embodiments of the present disclosure is shown in FIG. 7. First, the LLM is trained by using the sample data in the training sample set, and finally, a second key matrix K_{T} and a second value matrix V_{T} of each Transformer network are obtained. In the prediction process, the input text is predicted by using the LLM obtained through training. In the prediction process, each Transformer needs to perform self-attention processing by using K_{T} and V_{T} obtained through pre-training. For a specific process, refer to related records in the foregoing embodiments. There is a significant difference from the existing in-context learning shown in FIG. 1.

The foregoing method provided in some embodiments of the present disclosure is applied to multiple application scenarios, including but not limited to: sentiment analysis, intent recognition, question-answering processing, and the like. The method provided in the foregoing embodiments is described below by using sentiment analysis as an example.

First, labeled sample data is obtained to construct a training data set. The training data set includes multiple training samples, and each training sample includes input text samples and sentiment category labels corresponding to the input text samples. An example is shown in Table 1:

TABLE 1

| Input text sample | Sentiment category label |
|---|---|
| Food is yummy | Positive |
| Food is unpalatable | Negative |
| Bad dish | Negative |
| This vegetable soup is rich and thick | Positive |
| Tangy fragrance and unparalleled | Positive |
| deliciousness | |
| . . . | . . . |

The sentiment categories provided in the foregoing Table 1 are “positive”, “neutral”, and “negative” as examples, and is further divided into other sentiment categories of a thicker granularity or a thinner granularity. For example, the sentiment categories are divided into “excited”, “happy”, “placid”, “sad”, “annoyed”, and “angry”.

The text prediction model is trained by using the text sequence including the input text sample and a sentiment category label as an input of the text prediction model. For example, the text sequence “Evaluation: food is yummy. Sentiment category: positive” is constructed.

The text prediction model is obtained by performing model optimization based on the LLM obtained through pre-training. For a structure and a training process of the text prediction model, refer to related records in the foregoing method embodiments. The core content is that the LLM includes multiple layers of concatenated Transformer networks. In the training, each Transformer network is used as a current Transformer network layer to execute: determining, in a current round of iteration, a first key matrix, a first value matrix, and a first query matrix by using a feature representation outputted by a previous network layer; splicing the first key matrix and a second key matrix that is obtained by the current Transformer network layer in a previous round of iteration, to obtain a third key matrix, and splicing the first value matrix and a second value matrix that is obtained by the current Transformer network layer in the previous round of iteration, to obtain a third value matrix; performing processing of a self-attention mechanism by using the third key matrix, the third value matrix, and the first query matrix, to obtain a feature representation outputted by the current Transformer network layer; updating the second key matrix by using the first key matrix, and determining an updated second key matrix as a second key matrix that is obtained by the current Transformer network layer in the current round of iteration; and updating the second value matrix by using the first value matrix, and determining an updated second value matrix as a second value matrix that is obtained by the current Transformer network layer in the current round of iteration. Other details are not described herein.

When model training is performed, the Transformer network learns relationships between the input text samples and the sentiment category labels through self-attention processing. In the foregoing process, the key matrices and the value matrices are key carriers for expressing these relationships. The key matrix gradient and the value matrix gradient are considered as differences between relationships between input text samples and sentiment category labels that are learned through two rounds of iteration, and the obtained relationships tend to be consistent through continuous forward update.

In the model training process, the text prediction model retains historical information in each round of iteration, so as to fully understand and learn the labeled sample data. After the model training ends, the second key matrix

$${K}_{T}^{l}$$

and the second value matrix

$${V}_{T}^{l}$$

of each Transformer network layer that are obtained through training are stored, to be used in a sentiment analysis process.

When the sentiment analysis is performed by using the text prediction model obtained through training, for an unmarked input text, for example, “This dish is really mouth-watering”, as some implementable manners, “Evaluation: This dish is really mouth-watering” is used as a text sequence and inputted into the text prediction model, to obtain the sentiment category corresponding to the input text.

As some implementable manners, the text sequence obtained by splicing the input text and a prompt text is inputted into the text prediction model, to obtain the sentiment category corresponding to the input text. For example, the prompt text is “The sentiment expressed by the sentence is [Mask]”. For example, after the input text “This vegetable soup is rich and thick” and the prompt text are spliced, the text sequence “This vegetable soup is rich and thick, and the sentiment expressed by the sentence is [Mask]” is obtained. [Mask] is a mask part, and by encoding and predicting the text sequence, the text prediction model actually predicts content of the [Mask] part. A prediction result is actually mapped to a specific sentiment category in a sentiment category space.

Similarly, the text prediction model is a large language model. For a structure and a principle of the text prediction model, refer to related records in the foregoing embodiments. Details are not described herein again. The core content is that the large language model includes multiple layers of concatenated Transformer networks. Each Transformer network is used as a current Transformer network layer to execute: determining a first key matrix, a first value matrix, and a first query matrix by using a feature representation outputted by a previous network layer; splicing the first key matrix and a second key matrix

$${K}_{T}^{l}$$

that is obtained through pre-training by the current Transformer network layer, to obtain a third key matrix, and splicing the first value matrix and a second value matrix

$${V}_{T}^{l}$$

that is obtained through pre-training by the current Transformer network layer, to obtain a third value matrix; and performing processing of a self-attention mechanism by using the third key matrix, the third value matrix, and the first query matrix, to obtain a feature representation outputted by the current Transformer network layer.

As some implementable manners, the foregoing method for training a text prediction model or text prediction method is performed by a cloud server. The cloud server, also referred to as a cloud computing server or a cloud host, is a host product in a cloud computing service system, to resolve defects of high management difficulty and poor service scalability that exist in conventional physical host and virtual private server (VPS) services.

After obtaining an input text from a user terminal, the cloud server inputs a text sequence including the input text into a text prediction model, to obtain an output label corresponding to the input text, determines service content corresponding to the output label, and sending the service content to the user terminal. For example, a text inputted by a user in a smart customer service system is obtained, and sentiment analysis is performed on the text. Then, corresponding service content is provided to the user according to a sentiment category obtained through the sentiment analysis. For example, when it is recognized that the user is very annoyed, a human customer service is switched to for processing. When it is recognized that the user is happy, promotion information is sent to the user, and so on.

For a principle and a structure of the text prediction model, refer to related records in the foregoing method embodiments. Details are not described herein again.

The foregoing terminal device includes but is not limited to, for example, a smart mobile terminal, a smart household device, a wearable device, or a Personal Computer (PC). The smart mobile device may include, for example, a mobile phone, a tablet computer, a notebook computer, a Personal Digital Assistant (PDA), or an Internet automobile. The smart household device may include a smart television, a smart speaker, a smart refrigerator, or the like. The wearable device may include, for example, a smart watch, smart glasses, a virtual reality device, an augmented reality device, or a mixed reality device (that is, a device that can support virtual reality and augmented reality).

Specific embodiments of this specification are described above. Other embodiments fall within the scope of the appended claims. In some cases, actions or steps recorded in the claims are performed in sequences different from those in embodiments and an expected result may still be achieved. In addition, the processes depicted in the accompanying drawings are not necessarily performed in the specific order or successively to achieve an expected result. In some implementations, multitasking and parallel processing is feasible or beneficial.

According to some embodiments of another aspect, a text prediction model training apparatus is provided. The apparatus corresponds to the model training apparatus in the system shown in FIG. 2. FIG. 8 is a schematic block diagram of a model training apparatus according to some embodiments. As shown in FIG. 8, the apparatus 800 includes: a sample obtaining unit 801 and a model training unit 802. Main functions of the units are as follows.

The sample obtaining unit 801 is configured to obtain a training data set, the training data set including input text samples and output label samples corresponding to the input text samples.

The model training unit 802 is configured to train the text prediction model by using a text sequence including an input text sample and an output label corresponding to the input text sample as an input of a text prediction model. The text prediction model is an LLM, and the LLM includes multiple layers of concatenated Transformer networks. In the training, each Transformer network is used as a current Transformer network layer to execute: determining, in a current round of iteration, a first key matrix, a first value matrix, and a first query matrix by using a feature representation outputted by a previous network layer; splicing the first key matrix and a second key matrix that is obtained by the current Transformer network layer in a previous round of iteration, to obtain a third key matrix, and splicing the first value matrix and a second value matrix that is obtained by the current Transformer network layer in the previous round of iteration, to obtain a third value matrix; performing processing of a self-attention mechanism by using the third key matrix, the third value matrix, and the first query matrix, to obtain a feature representation outputted by the current Transformer network layer; updating the second key matrix by using the first key matrix, and determining an updated second key matrix as a second key matrix that is obtained by the current Transformer network layer in the current round of iteration; and updating the second value matrix by using the first value matrix, and determining an updated second value matrix as a second value matrix that is obtained by the current Transformer network layer in the current round of iteration.

Furthermore, the LLM further includes an embedding network, and the text prediction model further includes a prediction network.

The embedding network is used for performing embedding processing on the text sequence.

In response to the current Transformer network layer being a first Transformer network layer, the feature representation outputted by the previous network layer is a feature representation outputted by the embedding network. In response to the current Transformer network layer not being the first Transformer network layer, the feature representation outputted by the previous network layer is a feature representation outputted by a previous Transformer network layer.

The prediction network is used for predicting, by using a feature representation outputted by a last Transformer network layer, an output label corresponding to an input text sample.

As some implementable manners, in a current Transformer network layer, the second key matrix that is obtained by the current Transformer network layer in the previous round of iteration is updated in a manner of momentum gradient descent by using the first key matrix; and the second value matrix that is obtained by the current Transformer network layer in the previous round of iteration is updated in a manner of momentum gradient descent by using the first value matrix.

As some implementable manners, in a current Transformer network layer, element-by-element subtraction is performed by using the first key matrix and the second key matrix that is obtained by the current Transformer network layer in the previous round of iteration, to obtain a key matrix gradient; weighted summation is performed by using a key matrix momentum that is obtained by the current Transformer network layer in the previous round of iteration and the key matrix gradient, to obtain a key matrix momentum that is obtained by the current Transformer network layer in the current round of iteration; and the updated second key matrix is obtained by using the key matrix momentum that is obtained by the current Transformer network layer in the current round of iteration and the second key matrix that is obtained by the current Transformer network layer in the previous round of iteration.

Element-by-element subtraction is performed by using the first value matrix and the second value matrix that is obtained by the current Transformer network layer in the previous round of iteration, to obtain a value matrix gradient; weighted summation is performed by using a value matrix momentum that is obtained by the current Transformer network layer in the previous round of iteration and the value matrix gradient, to obtain a value matrix momentum that is obtained by the current Transformer network layer in the current round of iteration; and the updated second value matrix is obtained by using the value matrix momentum that is obtained by the current Transformer network layer in the current round of iteration and the second value matrix that is obtained by the current Transformer network layer in the previous round of iteration.

Furthermore, after each round of iteration is completed, in response to determining that a preset training termination condition is satisfied, the model training unit 802 stores a second key matrix and a second value matrix of each Transformer network layer that are obtained in the current iteration as a second key matrix and a second value matrix of each Transformer network layer that are obtained through training respectively.

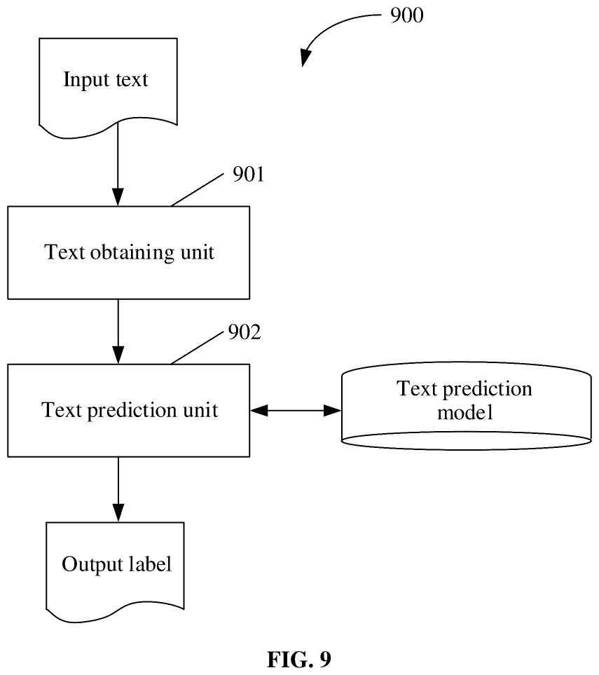

According to some embodiments of still another aspect, a text prediction apparatus is provided. FIG. 9 is a schematic block diagram of a text prediction apparatus according to some embodiments. As shown in FIG. 9, the apparatus 900 includes: a text obtaining unit 901 and a text prediction unit 902. Main functions of the units are as follows.

The text obtaining unit 901 is configured to obtain an input text.

The text prediction unit 902 is configured to input a text sequence including the input text into a text prediction model, to obtain an output label corresponding to the input text, where the text prediction model is an LLM, and the LLM includes multiple layers of concatenated Transformer networks. Each Transformer network is used as a current Transformer network layer to execute: determining a first key matrix, a first value matrix, and a first query matrix by using a feature representation outputted by a previous network layer; splicing the first key matrix and a second key matrix that is obtained through pre-training by the current Transformer network layer, to obtain a third key matrix, and splicing the first value matrix and a second value matrix that is obtained through pre-training by the current Transformer network layer, to obtain a third value matrix; and performing processing of a self-attention mechanism by using the third key matrix, the third value matrix, and the first query matrix, to obtain a feature representation outputted by the current Transformer network layer.

Furthermore, the LLM further includes an embedding network, and the text prediction model further includes a prediction network. The embedding network is used for performing embedding processing on the text sequence.

In response to the current Transformer network layer being a first Transformer network layer, the feature representation outputted by the previous network layer is a feature representation outputted by the embedding network. In response to the current Transformer network layer not being the first Transformer network layer, the feature representation outputted by the previous network layer is a feature representation outputted by a previous Transformer network layer.

The prediction network is used for predicting, by using a feature representation outputted by a last Transformer network layer, an output label corresponding to an input text.

Embodiments of this specification are all described in a progressive manner, for same or similar parts in embodiments, reference is made to these embodiments, and descriptions of each embodiment focus on a difference from other embodiments. Especially, an apparatus embodiment is basically similar to a method embodiment, and therefore is described briefly; for related parts, reference is made to partial descriptions in the method embodiment. The foregoing described apparatus embodiments are examples. The units described as separate parts may or may not be physically separate, and the parts displayed as units may or may not be physical units, is located in one position, or is distributed on multiple network units. Some or all of the modules is selected according to actual needs to achieve the objectives of the solutions of the embodiments. A person having ordinary skill in the art may understand and implement the method without any creative effort.

It should be noted that user information (including but not limited to user equipment information, user personal information, and the like) and data (including but not limited to data for analysis, stored data, displayed data, and the like) in the present disclosure are all information and data that are authorized by a user or that are fully authorized by all parties, and related data needs to be collected, used, and processed by complying with relevant laws, regulations, and standards of relevant countries and regions. In addition, a corresponding operation entry is provided for the user to select to authorize or reject. The functional units provided in the embodiments of the present disclosure may run in the method in the foregoing embodiments or a similar operation apparatus, or is stored as a part of a computer-readable storage medium.

In addition, some embodiments of the present disclosure further provides a computer-readable storage medium, where the program, when executed by a processor, implements the steps of the method according to any one of the foregoing method embodiments.

Optionally, the computer program, when executed by the processor, implements program code of the following steps:
obtaining a training data set, the training data set including input text samples and output labels corresponding to the input text samples;
training the text prediction model by using a text sequence including an input text sample and an output label corresponding to the input text sample as an input of the text prediction model, where the text prediction model is a large language model, and the large language model includes multiple layers of concatenated Transformer networks; and
in the training, each Transformer network is used as a current Transformer network layer to execute: determining, in a current round of iteration, a first key matrix, a first value matrix, and a first query matrix by using a feature representation outputted by a previous network layer; splicing the first key matrix and a second key matrix that is obtained by the current Transformer network layer in a previous round of iteration, to obtain a third key matrix, and splicing the first value matrix and a second value matrix that is obtained by the current Transformer network layer in the previous round of iteration, to obtain a third value matrix; performing processing of a self-attention mechanism by using the third key matrix, the third value matrix, and the first query matrix, to obtain a feature representation outputted by the current Transformer network layer; updating the second key matrix by using the first key matrix, and determining an updated second key matrix as a second key matrix that is obtained by the current Transformer network layer in the current round of iteration; and updating the second value matrix by using the first value matrix, and determining an updated second value matrix as a second value matrix that is obtained by the current Transformer network layer in the current round of iteration.

Optionally, the computer program, when executed by the processor, implements program code of the following steps:
obtaining an input text;
inputting a text sequence including the input text into a text prediction model, to obtain an output label corresponding to the input text; and where the text prediction model is a large language model, and the large language model includes multiple layers of concatenated Transformer networks; and
each Transformer network is used as a current Transformer network layer to execute: determining a first key matrix, a first value matrix, and a first query matrix by using a feature representation outputted by a previous network layer; splicing the first key matrix and a second key matrix that is obtained through pre-training by the current Transformer network layer, to obtain a third key matrix, and splicing the first value matrix and a second value matrix that is obtained through pre-training by the current Transformer network layer, to obtain a third value matrix; and performing processing of a self-attention mechanism by using the third key matrix, the third value matrix, and the first query matrix, to obtain a feature representation outputted by the current Transformer network layer.

Optionally, the computer program, when executed by the processor, implements program code of the following steps:
obtaining a training data set, the training data set including input text samples and sentiment category labels corresponding to the input text samples; and
training the text prediction model by using a text sequence including an input text sample and a sentiment category label corresponding to the input text sample as an input of the text prediction model, where the text prediction model is a large language model, and the large language model includes multiple layers of concatenated Transformer networks; and
in the training, each Transformer network is used as a current Transformer network layer to execute: determining, in a current round of iteration, a first key matrix, a first value matrix, and a first query matrix by using a feature representation outputted by a previous network layer; splicing the first key matrix and a second key matrix that is obtained by the current Transformer network layer in a previous round of iteration, to obtain a third key matrix, and splicing the first value matrix and a second value matrix that is obtained by the current Transformer network layer in the previous round of iteration, to obtain a third value matrix; performing processing of a self-attention mechanism by using the third key matrix, the third value matrix, and the first query matrix, to obtain a feature representation outputted by the current Transformer network layer; updating the second key matrix by using the first key matrix, and determining an updated second key matrix as a second key matrix that is obtained by the current Transformer network layer in the current round of iteration; and updating the second value matrix by using the first value matrix, and determining an updated second value matrix as a second value matrix that is obtained by the current Transformer network layer in the current round of iteration.

Optionally, the computer program, when executed by the processor, implements program code of the following steps:
obtaining an input text;
inputting a text sequence including the input text into a text prediction model, to obtain a sentiment category label corresponding to the input text, where the text prediction model is a large language model, and the large language model includes multiple layers of concatenated Transformer networks; and
each Transformer network is used as a current Transformer network layer to execute: determining a first key matrix, a first value matrix, and a first query matrix by using a feature representation outputted by a previous network layer; splicing the first key matrix and a second key matrix that is obtained through pre-training by the current Transformer network layer, to obtain a third key matrix, and splicing the first value matrix and a second value matrix that is obtained through pre-training by the current Transformer network layer, to obtain a third value matrix; and performing processing of a self-attention mechanism by using the third key matrix, the third value matrix, and the first query matrix, to obtain a feature representation outputted by the current Transformer network layer.

Optionally, the computer program, when executed by the processor, implements program code of the following steps:
obtaining an input text from a user terminal;
inputting a text sequence including the input text into a text prediction model, to obtain an output label corresponding to the input text; and
determining service content corresponding to the output label, and sending the service content to the user terminal,
where the text prediction model is a large language model, and the large language model includes multiple layers of concatenated Transformer networks; and
each Transformer network is used as a current Transformer network layer to execute: determining a first key matrix, a first value matrix, and a first query matrix by using a feature representation outputted by a previous network layer; splicing the first key matrix and a second key matrix that is obtained through pre-training by the current Transformer network layer, to obtain a third key matrix, and splicing the first value matrix and a second value matrix that is obtained through pre-training by the current Transformer network layer, to obtain a third value matrix; and performing processing of a self-attention mechanism by using the third key matrix, the third value matrix, and the first query matrix, to obtain a feature representation outputted by the current Transformer network layer.

The computer-readable storage medium may include a data signal propagating in a baseband or as part of a carrier wave and carrying a readable program code. A data signal propagated in such a way may assume multiple forms, including, but not limited to, an electromagnetic signal, an optical signal, or any appropriate combination thereof. The computer-readable storage medium may send, propagate, or transmit a program that is used by or used in combination with an instruction execution system, apparatus or device.

The program code included in the computer-readable storage medium is transmitted in any suitable medium, including but not limited to wireless, wired, optical cable, radio frequency, or the like, or any suitable combination of the above.

In addition, an electronic device includes:
at least one processor; and
a memory associated with the at least one processor, where the memory is configured to store program instructions, and the program instructions, when read and executed by the at least one processor, performs the steps of the method according to any one of the foregoing method embodiments.

The present disclosure further provides a computer program product, including a computer program, and the computer program, when executed by a processor, implements the steps of the method according to any one of the foregoing method embodiments.

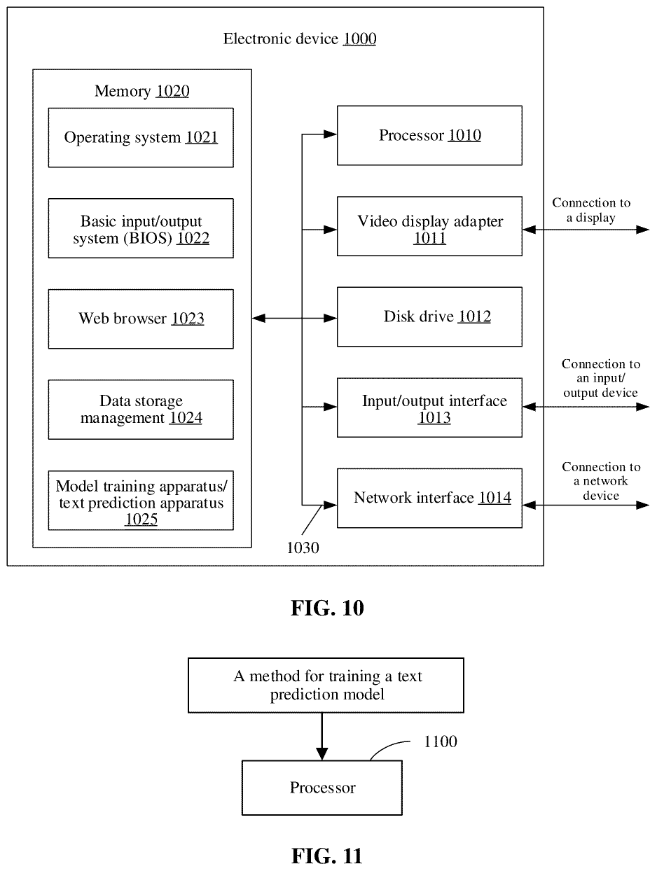

FIG. 10 shows an example of an architecture of an electronic device, which specifically includes a processor 1010, a video display adapter 1011, a disk drive 1012, an input/output interface 1013, a network interface 1014, and a memory 1020. The processor 1010, the video display adapter 1011, the disk drive 1012, the input/output interface 1013, and the network interface 1014 are communicatively connected with the memory 1020 by using a communication bus 1030.

The processor 1010 is implemented by a general-purpose CPU, a microprocessor, an application specific integrated circuit (ASIC), at least one integrated circuit, or the like, and is configured to execute relevant programs, to implement the technical solutions provided in the present disclosure.

The memory 1020 is implemented in the form of a read only memory (ROM), a random access memory (RAM), a static storage device, a dynamic storage device, or the like. The memory 1020 may store an operating system 1021 configured to control running of an electronic device 1000, and a basic input/output system (BIOS) 1022 configured to control a low-level operation of the electronic device 1000. In addition, the memory may further store a web browser 1023, a data storage management system 1024, a model training apparatus/text prediction apparatus 1025, and the like. The model training apparatus/text prediction apparatus 1025 is an application program that specifically implements operations in the foregoing steps in the embodiments of the present disclosure. In conclusion, when the technical solutions provided in the present disclosure are implemented by using software or firmware, related program code is stored in the memory 1020, and is invoked and executed by the processor 1010.

The input/output interface 1013 is configured to connect to an input/output module, to implement input and output of information. The input/output/module is configured in the device (not shown in the figure) as a component, or is externally connected with the device to provide a corresponding function. An input device may include a keyboard, a mouse, a touchscreen, a microphone, various sensors, and the like. An output device may include a display, a speaker, a vibrator, an indicator, and the like.

The network interface 1014 is configured to connect to a communication module (not shown in the figure), to implement communication and interaction between the device and another device. The communication module may implement communication in a wired manner (such as a USB or a network cable), or may implement communication in a wireless manner (such as a mobile network, Wi-Fi, or Bluetooth).

The bus 1030 includes a path for transmitting information between components (for example, the processor 1010, the video display adapter 1011, the disk drive 1012, the input/output interface 1013, and the network interface 1014, and the memory 1020) of the device.

It should be noted that although the foregoing device shows the processor 1010, the video display adapter 1011, the disk drive 1012, the input/output interface 1013, the network interface 1014, the memory 1020, and the bus 1030. In a specific implementation process, the device may further include another component essential for implementing normal running. In addition, a person having ordinary skill in the art may understand that, the foregoing device may alternatively include components necessary to implement the present disclosure, and does not necessarily include all the components shown in the figure.

Some embodiments of the present disclosure further provides a processor. FIG. 11 is a schematic structural diagram of a processor for implementing the embodiments of the present disclosure. As shown in FIG. 11, the processor 1100 is configured to run a program, where when being run by the processor, the program performs the method in the foregoing embodiments.

In some embodiments of the present disclosure, the processor 1100 may execute a running program of a method for training a text prediction model.

Optionally, in some embodiments, the processor 1100 is used for performing the following steps:
obtaining a training data set, the training data set including input text samples and output labels corresponding to the input text samples; and
training the text prediction model by using a text sequence including an input text sample and an output label corresponding to the input text sample as an input of the text prediction model, where the text prediction model is a large language model, and the large language model includes multiple layers of concatenated Transformer networks; and
in the training, each Transformer network is used as a current Transformer network layer to execute: determining, in a current round of iteration, a first key matrix, a first value matrix, and a first query matrix by using a feature representation outputted by a previous network layer; splicing the first key matrix and a second key matrix that is obtained by the current Transformer network layer in a previous round of iteration, to obtain a third key matrix, and splicing the first value matrix and a second value matrix that is obtained by the current Transformer network layer in the previous round of iteration, to obtain a third value matrix; performing processing of a self-attention mechanism by using the third key matrix, the third value matrix, and the first query matrix, to obtain a feature representation outputted by the current Transformer network layer; updating the second key matrix by using the first key matrix, and determining an updated second key matrix as a second key matrix that is obtained by the current Transformer network layer in the current round of iteration; and updating the second value matrix by using the first value matrix, and determining an updated second value matrix as a second value matrix that is obtained by the current Transformer network layer in the current round of iteration.

Optionally, in some embodiments, the processor 1100 is used for performing the following steps:
obtaining an input text;
inputting a text sequence including the input text into a text prediction model, to obtain an output label corresponding to the input text; and where the text prediction model is a large language model, and the large language model includes multiple layers of concatenated Transformer networks; and
each Transformer network is used as a current Transformer network layer to execute: determining a first key matrix, a first value matrix, and a first query matrix by using a feature representation outputted by a previous network layer; splicing the first key matrix and a second key matrix that is obtained through pre-training by the current Transformer network layer, to obtain a third key matrix, and splicing the first value matrix and a second value matrix that is obtained through pre-training by the current Transformer network layer, to obtain a third value matrix; and performing processing of a self-attention mechanism by using the third key matrix, the third value matrix, and the first query matrix, to obtain a feature representation outputted by the current Transformer network layer.

Optionally, in some embodiments, the processor 1100 is used for performing the following steps:
obtaining a training data set, the training data set including input text samples and sentiment category labels corresponding to the input text samples; and
training the text prediction model by using a text sequence including an input text sample and a sentiment category label corresponding to the input text sample as an input of the text prediction model, where the text prediction model is a large language model, and the large language model includes multiple layers of concatenated Transformer networks; and
in the training, each Transformer network is used as a current Transformer network layer to execute: determining, in a current round of iteration, a first key matrix, a first value matrix, and a first query matrix by using a feature representation outputted by a previous network layer; splicing the first key matrix and a second key matrix that is obtained by the current Transformer network layer in a previous round of iteration, to obtain a third key matrix, and splicing the first value matrix and a second value matrix that is obtained by the current Transformer network layer in the previous round of iteration, to obtain a third value matrix; performing processing of a self-attention mechanism by using the third key matrix, the third value matrix, and the first query matrix, to obtain a feature representation outputted by the current Transformer network layer; updating the second key matrix by using the first key matrix, and determining an updated second key matrix as a second key matrix that is obtained by the current Transformer network layer in the current round of iteration; and updating the second value matrix by using the first value matrix, and determining an updated second value matrix as a second value matrix that is obtained by the current Transformer network layer in the current round of iteration.

Optionally, in some embodiments, the processor 1100 is used for performing the following steps:
obtaining an input text;
inputting a text sequence including the input text into a text prediction model, to obtain a sentiment category label corresponding to the input text, where the text prediction model is a large language model, and the large language model includes multiple layers of concatenated Transformer networks; and
each Transformer network is used as a current Transformer network layer to execute: determining a first key matrix, a first value matrix, and a first query matrix by using a feature representation outputted by a previous network layer; splicing the first key matrix and a second key matrix that is obtained through pre-training by the current Transformer network layer, to obtain a third key matrix, and splicing the first value matrix and a second value matrix that is obtained through pre-training by the current Transformer network layer, to obtain a third value matrix; and performing processing of a self-attention mechanism by using the third key matrix, the third value matrix, and the first query matrix, to obtain a feature representation outputted by the current Transformer network layer.

Optionally, in some embodiments, the processor 1100 is used for performing the following steps:
obtaining an input text from a user terminal;
inputting a text sequence including the input text into a text prediction model, to obtain an output label corresponding to the input text; and
determining service content corresponding to the output label, and sending the service content to the user terminal,
where the text prediction model is a large language model, and the large language model includes multiple layers of concatenated Transformer networks; and
each Transformer network is used as a current Transformer network layer to execute: determining a first key matrix, a first value matrix, and a first query matrix by using a feature representation outputted by a previous network layer; splicing the first key matrix and a second key matrix that is obtained through pre-training by the current Transformer network layer, to obtain a third key matrix, and splicing the first value matrix and a second value matrix that is obtained through pre-training by the current Transformer network layer, to obtain a third value matrix; and performing processing of a self-attention mechanism by using the third key matrix, the third value matrix, and the first query matrix, to obtain a feature representation outputted by the current Transformer network layer.

It can be known based on the descriptions of the foregoing implementations that, a person having ordinary skill in the art may clearly understand that the present disclosure is implemented by software in combination with a necessary universal hardware platform. Based on such an understanding, the technical solutions in the present disclosure essentially or the part contributing to the existing technologies is implemented in the form of a computer program product. The computer program product is stored in a storage medium (for example, a read only memory (ROM)/random access memory (RAM), a magnetic disk or an optical disc), and includes several instructions for instructing a computer device (which is a personal computer, a server, a network device, or the like) to perform the method described in each or part of the present disclosure.

The technical solutions provided in the present disclosure are described above in detail. The principles and implementations of the present disclosure are described by using specific examples in this specification. The foregoing embodiments are used for helping understand the method and the core idea of the present disclosure. In addition, a person having ordinary skill in the art may change a specific implementation and an application scope according to the idea of the present disclosure. In conclusion, content of this specification is not to be construed as a limitation on the present disclosure.

### INDUSTRIAL APPLICABILITY

The solutions provided in the embodiments of the present disclosure is applied to a text prediction model training process. A training data set is obtained, the training data set including input text samples and output labels corresponding to the input text samples. The text prediction model is trained by using a text sequence including an input text sample and an output label corresponding to the input text sample as an input of the text prediction model, where the text prediction model is a large language model, and the large language model includes multiple layers of concatenated Transformer networks. In the training, each Transformer network is used as a current Transformer network layer to execute: determining, in a current round of iteration, a first key matrix, a first value matrix, and a first query matrix by using a feature representation outputted by a previous network layer; splicing the first key matrix and a second key matrix that is obtained by the current Transformer network layer in a previous round of iteration, to obtain a third key matrix, and splicing the first value matrix and a second value matrix that is obtained by the current Transformer network layer in the previous round of iteration, to obtain a third value matrix; performing processing of a self-attention mechanism by using the third key matrix, the third value matrix, and the first query matrix, to obtain a feature representation outputted by the current Transformer network layer; updating the second key matrix by using the first key matrix, and determining an updated second key matrix as a second key matrix that is obtained by the current Transformer network layer in the current round of iteration; and updating the second value matrix by using the first value matrix, and determining an updated second value matrix as a second value matrix that is obtained by the current Transformer network layer in the current round of iteration. Then, a technical problem of low efficiency of training the text prediction model is resolved.

1. A method for training a text prediction model, comprising:
obtaining a training data set, the training data set comprising input text samples and output labels corresponding to the input text samples;
training the text prediction model by using a text sequence comprising an input text sample and an output label corresponding to the input text sample as an input of the text prediction model, wherein the text prediction model is a large language model, and the large language model comprises a plurality of layers of concatenated Transformer networks; and
in the training, each Transformer network is used as a current Transformer network layer to execute: determining, in a current round of iteration, a first key matrix, a first value matrix, and a first query matrix by using a feature representation outputted by a previous network layer; splicing the first key matrix and a second key matrix that is obtained by the current Transformer network layer in a previous round of iteration, to obtain a third key matrix, and splicing the first value matrix and a second value matrix that is obtained by the current Transformer network layer in the previous round of iteration, to obtain a third value matrix; performing processing of a self-attention mechanism by using the third key matrix, the third value matrix, and the first query matrix, to obtain a feature representation outputted by the current Transformer network layer; updating the second key matrix by using the first key matrix, and determining an updated second key matrix as a second key matrix that is obtained by the current Transformer network layer in the current round of iteration; and updating the second value matrix by using the first value matrix, and determining an updated second value matrix as a second value matrix that is obtained by the current Transformer network layer in the current round of iteration.

2. The method according to claim 1, wherein the large language model further comprises an embedding network, and the text prediction model further comprises a prediction network; the embedding network is used for performing embedding processing on the text sequence;
in response to the current Transformer network layer being a first Transformer network layer, the feature representation outputted by the previous network layer is a feature representation outputted by the embedding network; in response to the current Transformer network layer not being the first Transformer network layer, the feature representation outputted by the previous network layer is a feature representation outputted by a previous Transformer network layer; and
the prediction network is used for predicting, by using a feature representation outputted by a last Transformer network layer, the output label corresponding to the input text sample.

3. The method according to claim 1, wherein updating the second key matrix by using the first key matrix comprises: updating, in a manner of momentum gradient descent by using the first key matrix, the second key matrix that is obtained by the current Transformer network layer in the previous round of iteration; and
updating the second value matrix by using the first value matrix comprises: updating, in a manner of momentum gradient descent by using the first value matrix, the second value matrix that is obtained by the current Transformer network layer in the previous round of iteration.

4. The method according to claim 3, wherein updating, in the manner of momentum gradient descent by using the first key matrix, the second key matrix that is obtained by the current Transformer network layer in the previous round of iteration comprises: performing element-by-element subtraction by using the first key matrix and the second key matrix that is obtained by the current Transformer network layer in the previous round of iteration, to obtain a key matrix gradient; performing weighted summation by using a key matrix momentum that is obtained by the current Transformer network layer in the previous round of iteration and the key matrix gradient, to obtain a key matrix momentum that is obtained by the current Transformer network layer in the current round of iteration; and obtaining the updated second key matrix by using the key matrix momentum that is obtained by the current Transformer network layer in the current round of iteration and the second key matrix that is obtained by the current Transformer network layer in the previous round of iteration; and
updating, in the manner of momentum gradient descent by using the first value matrix, the second value matrix that is obtained by the current Transformer network layer in the previous round of iteration comprises: performing element-by-element subtraction by using the first value matrix and the second value matrix that is obtained by the current Transformer network layer in the previous round of iteration, to obtain a value matrix gradient; performing weighted summation by using a value matrix momentum that is obtained by the current Transformer network layer in the previous round of iteration and the value matrix gradient, to obtain a value matrix momentum that is obtained by the current Transformer network layer in the current round of iteration; and obtaining the updated second value matrix by using the value matrix momentum that is obtained by the current Transformer network layer in the current round of iteration and the second value matrix that is obtained by the current Transformer network layer in the previous round of iteration.

5. The method according to claim 1, wherein after each round of iteration is completed, in response to determining that a preset training termination condition is satisfied, a second key matrix and a second value matrix of each Transformer network layer that are obtained in the current iteration are stored as a second key matrix and a second value matrix of each Transformer network layer that are obtained through training respectively.

6-7. (canceled)

8. A method for training a text prediction model, comprising:
obtaining a training data set, the training data set comprising input text samples and sentiment category labels corresponding to the input text samples; and
training the text prediction model by using a text sequence comprising an input text sample and a sentiment category label corresponding to the input text sample as an input of the text prediction model, wherein the text prediction model is a large language model, and the large language model comprises a plurality of layers of concatenated Transformer networks; and
in the training, each Transformer network is used as a current Transformer network layer to execute: determining, in a current round of iteration, a first key matrix, a first value matrix, and a first query matrix by using a feature representation outputted by a previous network layer; splicing the first key matrix and a second key matrix that is obtained by the current Transformer network layer in a previous round of iteration, to obtain a third key matrix, and splicing the first value matrix and a second value matrix that is obtained by the current Transformer network layer in the previous round of iteration, to obtain a third value matrix; performing processing of a self-attention mechanism by using the third key matrix, the third value matrix, and the first query matrix, to obtain a feature representation outputted by the current Transformer network layer; updating the second key matrix by using the first key matrix, and determining an updated second key matrix as a second key matrix that is obtained by the current Transformer network layer in the current round of iteration; and updating the second value matrix by using the first value matrix, and determining an updated second value matrix as a second value matrix that is obtained by the current Transformer network layer in the current round of iteration.

9. The method according to claim 8, wherein the large language model further comprises an embedding network, and the text prediction model further comprises a prediction network; the embedding network is used for performing embedding processing on the text sequence;
in response to the current Transformer network layer being a first Transformer network layer, the feature representation outputted by the previous network layer is a feature representation outputted by the embedding network; in response to the current Transformer network layer not being the first Transformer network layer, the feature representation outputted by the previous network layer is a feature representation outputted by a previous Transformer network layer; and
the prediction network is used for predicting, by using a feature representation outputted by a last Transformer network layer, the output label corresponding to the input text sample.

10. The method according to claim 8, wherein updating the second key matrix by using the first key matrix comprises: updating, in a manner of momentum gradient descent by using the first key matrix, the second key matrix that is obtained by the current Transformer network layer in the previous round of iteration; and
updating the second value matrix by using the first value matrix comprises: updating, in a manner of momentum gradient descent by using the first value matrix, the second value matrix that is obtained by the current Transformer network layer in the previous round of iteration.

11. The method according to claim 10, wherein updating, in the manner of momentum gradient descent by using the first key matrix, the second key matrix that is obtained by the current Transformer network layer in the previous round of iteration comprises: performing element-by-element subtraction by using the first key matrix and the second key matrix that is obtained by the current Transformer network layer in the previous round of iteration, to obtain a key matrix gradient; performing weighted summation by using a key matrix momentum that is obtained by the current Transformer network layer in the previous round of iteration and the key matrix gradient, to obtain a key matrix momentum that is obtained by the current Transformer network layer in the current round of iteration; and obtaining the updated second key matrix by using the key matrix momentum that is obtained by the current Transformer network layer in the current round of iteration and the second key matrix that is obtained by the current Transformer network layer in the previous round of iteration; and
updating, in the manner of momentum gradient descent by using the first value matrix, the second value matrix that is obtained by the current Transformer network layer in the previous round of iteration comprises: performing element-by-element subtraction by using the first value matrix and the second value matrix that is obtained by the current Transformer network layer in the previous round of iteration, to obtain a value matrix gradient; performing weighted summation by using a value matrix momentum that is obtained by the current Transformer network layer in the previous round of iteration and the value matrix gradient, to obtain a value matrix momentum that is obtained by the current Transformer network layer in the current round of iteration; and obtaining the updated second value matrix by using the value matrix momentum that is obtained by the current Transformer network layer in the current round of iteration and the second value matrix that is obtained by the current Transformer network layer in the previous round of iteration.

12-16. (canceled)

17. An electronic device, comprising:
at least one processor; and
a memory associated with the at least one processor, wherein the memory is configured to store program instructions, and the program instructions, when read and executed by the at least one processor, performs the following steps:
obtaining a training data set, the training data set comprising input text samples and output labels corresponding to the input text samples;
training the text prediction model by using a text sequence comprising an input text sample and an output label corresponding to the input text sample as an input of the text prediction model, wherein the text prediction model is a large language model, and the large language model comprises a plurality of layers of concatenated Transformer networks; and
in the training, each Transformer network is used as a current Transformer network layer to execute: determining, in a current round of iteration, a first key matrix, a first value matrix, and a first query matrix by using a feature representation outputted by a previous network layer; splicing the first key matrix and a second key matrix that is obtained by the current Transformer network layer in a previous round of iteration, to obtain a third key matrix, and splicing the first value matrix and a second value matrix that is obtained by the current Transformer network layer in the previous round of iteration, to obtain a third value matrix; performing processing of a self-attention mechanism by using the third key matrix, the third value matrix, and the first query matrix, to obtain a feature representation outputted by the current Transformer network layer; updating the second key matrix by using the first key matrix, and determining an updated second key matrix as a second key matrix that is obtained by the current Transformer network layer in the current round of iteration; and updating the second value matrix by using the first value matrix, and determining an updated second value matrix as a second value matrix that is obtained by the current Transformer network layer in the current round of iteration.

18-20. (canceled)

21. The method according to claim 2, wherein after each round of iteration is completed, in response to determining that a preset training termination condition is satisfied, a second key matrix and a second value matrix of each Transformer network layer that are obtained in the current iteration are stored as a second key matrix and a second value matrix of each Transformer network layer that are obtained through training respectively.

22. The method according to claim 3, wherein after each round of iteration is completed, in response to determining that a preset training termination condition is satisfied, a second key matrix and a second value matrix of each Transformer network layer that are obtained in the current iteration are stored as a second key matrix and a second value matrix of each Transformer network layer that are obtained through training respectively.

23. The method according to claim 4, wherein after each round of iteration is completed, in response to determining that a preset training termination condition is satisfied, a second key matrix and a second value matrix of each Transformer network layer that are obtained in the current iteration are stored as a second key matrix and a second value matrix of each Transformer network layer that are obtained through training respectively.

24. The method according to claim 1, wherein the output label corresponding to the input text sample is an output label marked by the input text sample.

25. The method according to claim 5, wherein the preset training termination condition comprises at least one of the following:
an accuracy on a verification set reaching a preset accuracy threshold; and
a plurality of iterations reaching a preset iteration quantity threshold.

26. The method according to claim 1, wherein the method further comprises:
obtaining an input text; and
inputting a text sequence comprising the input text into the text prediction model, to obtain an output label corresponding to the input text.

27. The method according to claim 26, wherein the text sequence comprising the input text comprises at least one of the following:
regarding the input text as the text sequence;
forming the text sequence by using the input text and indication information of the input text; and
splicing the input text and a preset prompt text to form the text sequence.

28. The method according to claim 26, wherein the text prediction model comprises an embedding network, a plurality of Transformer networks and a prediction network, obtaining the output label corresponding to the input text predicted by the text prediction model comprises:
performing Embedding processing on the text sequence by using the embedding network;
performing encoding to obtain a feature representation of the text sequence by using multiple Transformer networks; and
predicting the output label corresponding to the input text by the prediction network using the feature representation of the text sequence.

29. The method according to claim 1, wherein the method is performed by a cloud server.

30. The method according to claim 29, wherein the method further comprises:
after the cloud server obtaining an input text from a user terminal, the cloud server inputting a text sequence comprising the input text into the text prediction model, to obtain an output label corresponding to the input text; and
the cloud server determining service content corresponding to the output label, and sending the service content to the user terminal.
